(19) United States
(12) Patent Application Publication
(10) Pub. No.: US 2010/0313781 A1
(43) Pub. Date: Dec. 16, 2010

(54) FEEDFORWARD CONTROL OF DOWNSTREAM REGISTER ERRORS FOR ELECTRONIC ROLL-TO-ROLL PRINTING SYSTEM

(75) Inventors: Kee-Hyun Shin, Seongnam-si (KR); Hyun-Kyoo Kang, Goyang-si (KR)

Correspondence Address: LRK Patent Law Firm, 1952 Gallows Rd, Suite 200, Vienna, VA, 22182, US

(73) Assignee: KONKUK UNIVERSITY INDUSTRIAL COOPERATION CORP., Seoul (KR)

(21) Appl. No.: 12/867,940

(22) PCT Filed: Jun. 28, 2008
(86) PCT No.: PCT/KR08/03761

§ 371 Date: Aug. 17, 2010

(30) Foreign Application Priority Data
Feb. 19, 2008 (KR) 10-2008-0014933

(51) Int. Cl. B41F 1/34

(52) U.S. Cl. 101/481

(57) ABSTRACT

The present invention relates, in general, to a continuous roll-to-roll printing method for manufacturing electronic devices, and, more particularly, to an ultra-precision register control method in a continuous roll-to-roll printing process for manufacturing electronic devices, which compensates for register errors attributable to variations in the speed of upstream printing cylinders by using a feedforward control logic, thus eliminating additional register errors. The ultra-precision register control method in a continuous roll-to-roll printing process for manufacturing electronic devices, register errors, attributable to variations in speed of upstream printing cylinders are compensated for using feedforward control logic. According to the present invention, the effect of compensating for only the register errors of a current span is obtained, and thus there is an excellent advantage in that precise register control of a printing system can be realized compared to the case using typical feedback control logic.

### TECHNICAL FIELD

The present invention relates, in general, to a continuous roll-to-roll printing method for manufacturing electronic devices, and, more particularly, to an ultra-precision register control method in a continuous roll-to-roll printing process for manufacturing electronic devices, which compensates for register errors attributable to variations in the speed of upstream printing cylinders by using a feedforward control logic, thus eliminating additional register errors.

### BACKGROUND ART

Recently, attention has been focused on mass production of low-cost electronic devices through a continuous roll-to-roll printing process used in a typical printing process. The production of electronic devices through a conventional batch method did not exhibit high productivity due to an intermittent production method and the complexity of a production process attributable to etching or the like.

In contrast, roll-to-roll production using a continuous process enables materials to be continuously produced, and directly prints ink, which includes metal nanoparticles such as silver or nickel, on a material, thus rapidly increasing production speed. However, there is a problem in that, in order to apply a typical printing process, used in general printing media, to roll-to-roll printing for electronic devices, printing precision must be increased. The precision of a typical printing process is about 100 microns, which is the minimum error that can be detected by human eyes. However, such an electronic device requires a printing precision of 1˜50 microns or less according to the target of application thereof.

Typical continuous process-based printers may include a sectional type register controller and a compensator roll type register controller. In a recent continuous printing process, a sectional type register controller has been used.

In detail, with reference to FIGS. 1 and 2, respective controllers will be described below.

FIG. 1 is a diagram showing the construction of a compensator roll type register controller. Referring to FIG. 1, the compensator roll type register controller transfers a driving force using a single main motor, thus rotating respective printing cylinders. In this case, it can be seen that, at each roller, a gearbox is installed, and all printing cylinders are rotating at the same speed. Further, compensator rolls are installed between respective printing cylinders, and span lengths are controlled through the motion of the compensator rolls, and thus a printing position is controlled. However, in this scheme, since additional equipment, such as compensator rolls, a main motor, a gearbox, and a linear motion guide, must be installed, efficiency is relatively low from the standpoint of costs and spatial utility.

In order to overcome this disadvantage, the sectional type register controller of FIG. 2 is used. The sectional type register controller employs a scheme in which a shaft is removed and respective printing cylinders are driven using individual motors, so that individual speed control of the printing cylinders is possible, and thus compensator rolls may be omitted.

Therefore, a method of controlling register errors may differ. In a conventional compensator roll type printer, register errors are compensated for in such a way as to cause phase difference between printing cylinders by changing span length through the motion of compensator rolls. In contrast, in a sectional type printer, errors are compensated for in such a way as to change the speeds of the motors on respective printing cylinders. That is, the sectional type printer uses a principle by which register errors are compensated for by changing the phases of printing cylinders in proportion to the magnitudes of register errors.

The point that must be regarded as the most important factor in the sectional type printer is that the motion of compensator rolls does not influence the length of a subsequent span in the conventional compensator roll type printer, but the speed input of printing cylinders for error compensation purposes directly influences variation between previous and subsequent phases of each printing cylinder in the sectional type printer. Therefore, although errors in the current span are compensated for, register errors also occur in the subsequent span due to the errors in the current span.

This is shown in FIG. 3. FIG. 3 illustrates a graph and construction showing register errors between first and second printing cylinders and between second and third printing cylinders when the speed of the second printing cylinder is changed using a pulse. It can be seen that respective register errors Y₂ and Y₃ occur and that they have the same magnitude in different directions.

In a typical printing system, in order to compensate for these errors, register errors caused in respective spans have been controlled by using a feedback control method such as Proportional-Integral-Derivative (PID) control in each printing cylinder. However, in order to realize ultra-precision register control for roll-to-roll printing of electronic devices, the probability of the occurrence of register errors must be reduced by compensating in advance for register errors, which will occur in a subsequent span, using an accurate value.

### DISCLOSURE OF INVENTION

### Technical Problem

In order to solve the above problems, the present inventor has done research and made efforts for many years, and, as a result, has completed the present invention by developing an upstream register compensation control technique, required to compensate for register errors in a subsequent span occurring due to the speed input of a printing cylinder through the use of both a register model and a tension model.

Accordingly, an object of the present invention is to provide an ultra-precision register control method in a continuous roll-to-roll printing process for manufacturing electronic devices, which compensates for register errors attributable to variations in the speed of upstream printing cylinders by using feedforward control logic, thus eliminating additional register errors.

Another object of the present invention is to provide an ultra-precision register control method, which improves the precision of printing, thus enabling the implementation of a roll-to-roll electronic device printing system suitable for the printing of electronic devices.

### Technical Solution

In order to accomplish the above objects, the present invention provides an ultra-precision register control method in a continuous roll-to-roll printing process for manufacturing electronic devices, comprising the step of compensating for register errors, attributable to variations in speed of upstream printing cylinders, using feedforward control logic.

Preferably, the feedforward control logic comprises the steps of controlling tension of a material, input to a first printing cylinder through an unwinder section and an infeed section; calculating a register error for the material, having passed through a second printing cylinder, using a register sensor installed behind the second printing cylinder, and thereafter calculating a first feedback control compensation signal using a feedback controller; inputting the first feedback control compensation signal to the second printing cylinder; calculating a register error for the material having passed through a third printing cylinder, using a register sensor installed behind the third printing cylinder, and thereafter calculating a second feedback control compensation signal using a feedback controller while calculating a first lead compensation control signal using a feedforward controller by utilizing the signal input to the second printing cylinder as an input value; and inputting a value, obtained by adding the second feedback control compensation signal to the first lead compensation control signal, to the third printing cylinder.

Preferably, the feedforward control logic further comprises the steps of calculating a register error for the material having passed through a fourth printing cylinder using a register sensor installed behind the fourth printing cylinder, and thereafter calculating a third feedback control compensation signal using a feedback controller while calculating a second lead compensation control signal using a feedforward controller by utilizing the signal input to the third printing cylinder as an input value; and inputting a value, obtained by adding the third feedback control compensation signal to the second lead compensation control signal, to the fourth printing cylinder.

Preferably, speed of the third printing cylinder is represented by the following equation:

$${V}_{3} ( s ) = [ 1 - \frac{1}{τ s + 1} + {e}^{- τ s} ] {V}_{2} ( s )$$

where V₃ is the speed of the third printing cylinder, V₂ is speed of the second printing cylinder, τ is a time constant, and s is a Laplace domain variable (complex variable).

### ADVANTAGEOUS EFFECTS

The ultra-precision register control method according to the present invention has the following excellent advantages.

First, the ultra-precision register control method of the present invention compensates for register errors attributable to variations in the speed of upstream printing cylinders by using feedforward control logic, thus eliminating additional register errors.

Further, the ultra-precision register control method of the present invention improves the precision of printing, thus enabling the implementation of a roll-to-roll electronic device printing system suitable for the printing of electronic devices.

### BRIEF DESCRIPTION OF DRAWINGS

FIG. 1 is a diagram showing the construction of a compensator roll type register controller;

FIG. 2 is a diagram showing the construction of a sectional type register controller;

FIG. 3 illustrates a graph and construction showing register errors between first and second printing cylinders and between second and third printing cylinders when the speed of the second printing cylinder is changed using a pulse;

FIG. 4 is a diagram showing the construction of a printing system having three printing cylinders;

FIG. 5 is a view showing the amount of control input V₃;

FIG. 6 is a view showing register errors Y₂ and Y₃; and

FIG. 7 is a diagram showing control signals required to compensate for register errors.

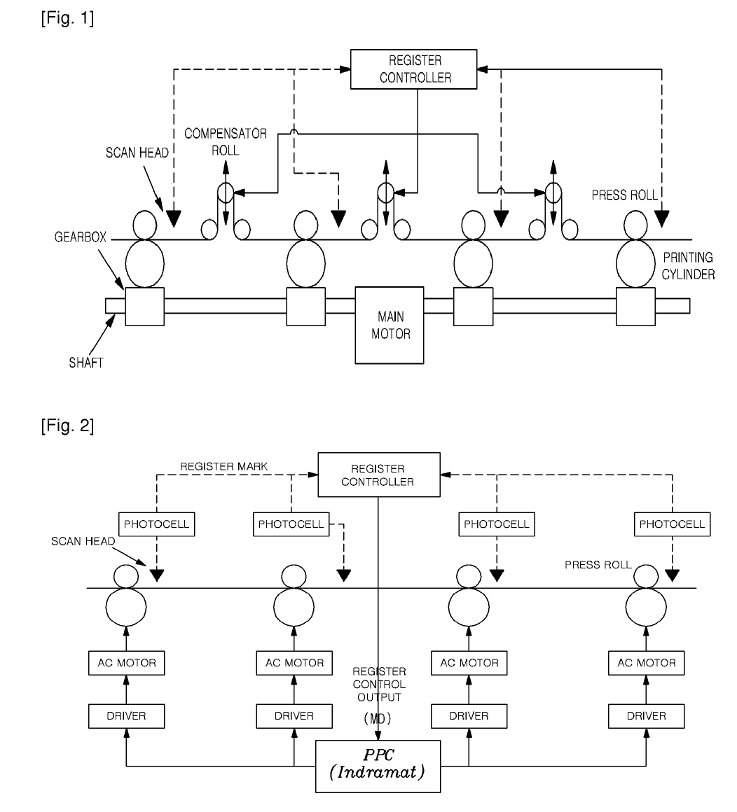

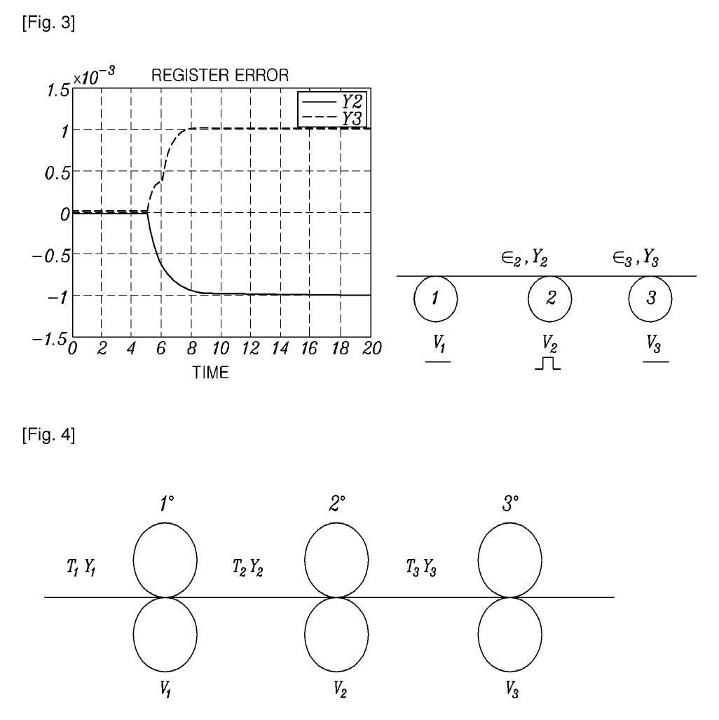

### BEST MODE FOR CARRYING OUT THE INVENTION

Hereinafter, the technical construction of the present invention will be described in detail with reference to the attached drawings and preferred embodiments.

FIG. 4 is a diagram showing a printing system having three printing cylinders. A process for designing an upstream register compensation controller according to the present invention using the register and tension model of each span will be described in detail below.

1. Tension Model

The following equations represent the tension models of a system having two spans, as shown in FIG. 4,

$$\begin{matrix}\frac{d}{d t} [ {T}_{2} ( t ) ] = - \frac{{v}_{20}}{L} {T}_{2} ( t ) + \frac{{v}_{10}}{L} {T}_{1} ( t ) + \frac{AE}{L} ( {V}_{2} ( t ) - {V}_{1} ( t ) ) & ( 1 ) \\ \frac{d}{d t} [ {T}_{3} ( t ) ] = - \frac{{v}_{30}}{L} {T}_{3} ( t ) + \frac{{v}_{20}}{L} {T}_{2} ( t ) + \frac{AE}{L} ( {V}_{3} ( t ) - {V}_{2} ( t ) ) & ( 2 )\end{matrix}$$

where Tᵢ: i-th tension (N), νᵢₒ: initial speed of i-th printing cylinder (m/s), L: length of span (m), νᵢ: variation in speed of i-th printing cylinder (m/s), A: area of material (m²), and E: modulus of direct elasticity (N/m²).

2. Register Error Model

The register models of a system having two spans, as shown in FIG. 4 are given by the following Equations (1) and (2),

$$\begin{matrix}{Y}_{2} = \frac{\overline{v}}{s} ( - {H}_{2} + {H}_{1} {e}^{- τ s} ) & ( 1 ) \\ {Y}_{3} = \frac{\overline{v}}{s} ( - {H}_{3} + {H}_{2} {e}^{- τ s} ) & ( 2 )\end{matrix}$$

where, τ is a time constant (sec),

Hᵢ

: strain of an i-th span, Yᵢ: register error of i-th span, and

ν̅

: operation speed (m/s). Further,

Hᵢ(t=1, 2, 3) is variation in strain and satisfies the relationship of Equation (3),

Tᵢ=AEHᵢ (3)

where A is the area of a material, and E is the modulus of direct elasticity of the material.

A compensation value required to compensate for the register error Y3 using the relationship between the tension and the register is represented by the following Equation (4),

$${V}_{3} ( s ) = [ 1 - \frac{1}{τ s + 1} + {e}^{- τ s} ] {V}_{2} ( s ) \qquad ( 4 )$$

where V₃ is the speed of a third printing cylinder, V₂ is the speed of a second printing cylinder, τ is a time constant, and s is a Laplace domain variable (complex variable).

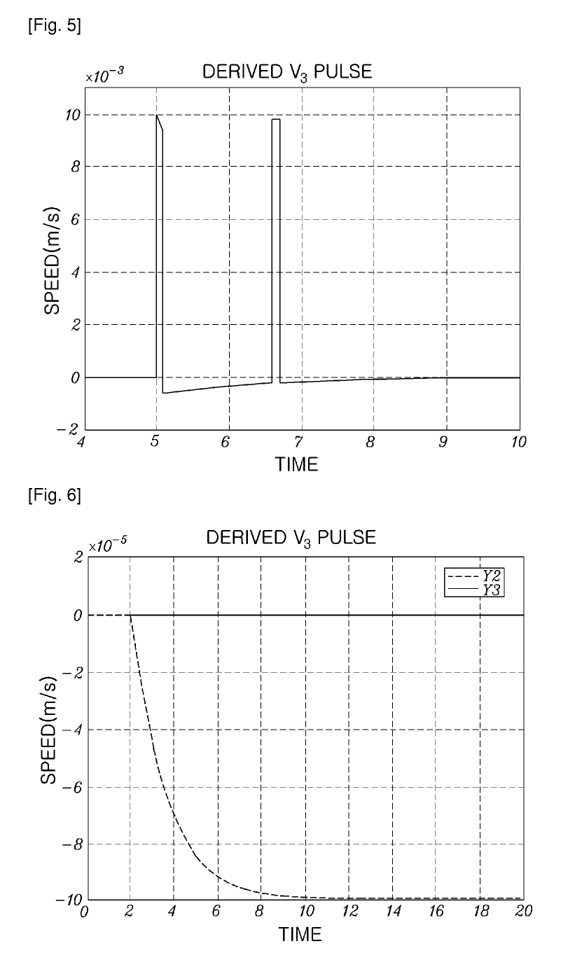

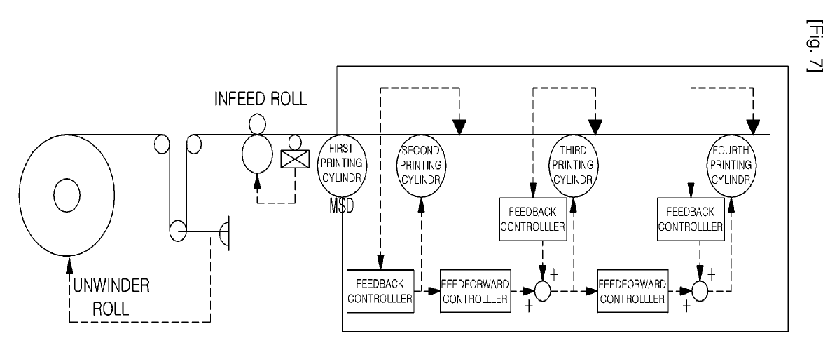

In detail, V₃ has the form of FIG. 5. When input V₃ is given as shown in FIG. 5, register errors Y₂ and Y₃ are given, as shown in FIG. 6.

That is, when register errors are compensated for, pulse inputs having the same phase are applied, but the speed of a subsequent roll is input according to the distribution of FIG. 5 on the basis of the speed, at which errors become “0” in the mathematical model of register errors, in order to decrease register errors occurring in the subsequent span.

The speeds of downstream printing cylinders are controlled through this method, and thus undesired downstream register errors attributable to the compensation for register errors can be compensated for, as shown in FIG. 6.

With reference to FIG. 7, an ultra-precision register control method in a continuous roll-to-roll printing process for manufacturing electronic devices will be described in detail.

First, the tension of a material input to a first printing cylinder through an unwinder section and an infeed section is controlled.

Next, for the material having passed through the first and second printing cylinders, a register error is calculated by a register sensor (a vision system, an optical sensor, a laser displacement measurement sensor, etc.) installed behind the second printing cylinder, and thereafter a first feedback control compensation signal is calculated by a feedback controller. The calculated first feedback control compensation signal is input to the second printing cylinder.

For the material having passed through the second and third printing cylinders, a register error is calculated by a register sensor installed behind the third printing cylinder, and thereafter a second feedback control compensation signal is calculated by a feedback controller at the same time that a first lead compensation control signal is calculated by a feedforward controller using the first feedback control compensation signal, input to the second printing cylinder, as an input value.

A value obtained by adding the second feedback control compensation signal to the first lead compensation control signal is input to the third printing cylinder.

For the material having passed through the third and fourth printing cylinders, a register error is calculated by a register sensor installed behind the fourth printing cylinder, and thereafter a third feedback control compensation signal is calculated by a feedback controller at the same time that a second lead compensation control signal is calculated by a feedforward controller using the signal, input to the third printing cylinder (second feedback control compensation signal+first lead compensation control signal), as an input value.

A value obtained by adding the third feedback control compensation signal to the second lead compensation control signal is input to the fourth printing cylinder.

Through the above method, register errors attributable to variations in the speed of upstream printing cylinders are compensated for using feedforward control logic, thus enabling additional register errors to be eliminated. As a result, the effect of compensating for only register errors of a current span is obtained. Therefore, compared to the case using only typical feedback control logic as in the conventional technology, the present invention realizes more precise register control of a printing system, and thus enables the implementation of a roll-to-roll electronic device printing system.

Although the present invention has been described with reference to preferred embodiments, those embodiments are only exemplary, and those skilled in the art will appreciate that various modifications and equivalent embodiments of the above embodiments are possible. The technical scope of the present invention should be defined by the accompanying claims.

1. An ultra-precision register control method in a continuous roll-to-roll printing process for manufacturing electronic devices, comprising the step of:
compensating for register errors, attributable to variations in speed of upstream printing cylinders, using feedforward control logic.

2. The ultra-precision register control method according to claim 1, wherein the feedforward control logic comprises the steps of:
controlling tension of a material, input to a first printing cylinder through an unwinder section and an infeed section;
calculating a register error for the material, having passed through a second printing cylinder, using a register sensor installed behind the second printing cylinder, and thereafter calculating a first feedback control compensation signal using a feedback controller;
inputting the first feedback control compensation signal to the second printing cylinder;
calculating a register error for the material having passed through a third printing cylinder, using a register sensor installed behind the third printing cylinder, and thereafter calculating a second feedback control compensation signal using a feedback controller while calculating a first lead compensation control signal using a feedforward controller by utilizing the signal input to the second printing cylinder as an input value; and
inputting a value, obtained by adding the second feedback control compensation signal to the first lead compensation control signal, to the third printing cylinder.

3. The ultra-precision register control method according to claim 2, wherein the feedforward control logic further comprises the steps of:
calculating a register error for the material having passed through a fourth printing cylinder using a register sensor installed behind the fourth printing cylinder, and thereafter calculating a third feedback control compensation signal using a feedback controller while calculating a second lead compensation control signal using a feedforward controller by utilizing the signal input to the third printing cylinder as an input value; and
inputting a value, obtained by adding the third feedback control compensation signal to the second lead compensation control signal, to the fourth printing cylinder.

4. The ultra-precision register control method according to claim 2, wherein speed of the third printing cylinder is represented by the following equation:
$${V}_{3} ( s ) = [ 1 - \frac{1}{τ s + 1} + {e}^{- τ s} ] {V}_{2} ( s )$$
where Vᵢ₊₁ is speed of an i+1-th printing cylinder, Vᵢ is speed of an i-th printing cylinder, τ is a time constant, s is a Laplace domain variable (complex variable), and i=1, 2, 3, 4, . . . .
